(19) United States
(12) Patent Application Publication
(10) Pub. No.: US 2020/0246834 A1
(43) Pub. Date: Aug. 6, 2020

(54) Automatic Bird Seed Cleaning

(71) Applicant: Son Thach Nguyen, Westminter, CO (US)

(72) Inventor: Son Thach Nguyen, Westminter, CO (US)

(21) Appl. No.: 16/265,904

(22) Filed: Feb. 1, 2019

(51) Int. Cl. B07B 4/02

(52) U.S. Cl. CPC B07B 4/02

(57) ABSTRACT

An apparatus for cleaning commercially-available, bulk bird seed is disclosed. The invention being mainly comprised of three main parts: a first part being a rectangular-shaped container; a second part being collection chambers; and a third part being an adjustable fan . A user pours bird seed into an open slot in the case. As the seed enters the case, a fan is used to entrain the seeds. Heavier, viable seeds fall out of the air stream into one chamber of the device, and lighter, fugitive husk falls out of the air stream into another chamber. An object of the invention is to automatically segregate and clean bird seed in preparation for feeding birds of various sizes.

### FIELD OF THE INVENTION

The present invention relates generally to bird seed. More specifically, it relates to an apparatus that cleans bird seed by non-mechanical means.

### BACKGROUND OF THE INVENTION

Birds consume seeds by removing the shells of the seeds from the kernels and eating the kernels. The shells (husks) are waste material that can build up inside a feeder along with smaller seed inside the feeder cup and needs to be routinely emptied. Fugitive husks are also usually mixed in with the seed in the top layer. These fugitive husks vary in size from whole shells to smaller broken pieces and can prevent birds from finding the nutritious seed. To get access to the seed below the husks, birds will dig through the top layer (usually with their heads and beaks) and throw the husks and bird seed mixture out of the feeder, wasting seed and creating a mess at the feeder. The birds can also breathe in the husks and get them in their eyes—in extreme cases they can even choke on them. Three traditional ways to get rid of the husks include: disposing of all of the husks along with the uneaten seed, sift off the top layer of the seed and husk mixture by hand, or blow on the mixture to remove the husk. All three methods are inefficient and waste seed. The amount of seed discarded when pouring out the seed (either fully or just the top layer) is often equal to the amount of husk. Manually blowing on the seed husk mixture or pouring off the top layer can also leave a lot of husks behind.

There is a need for a compact device that separates husks from the seed quickly, easily and in an economical way. The present invention fulfills these requirements. U.S. Pat. No. 775,965 disclosed a device that uses air to separate material with different weights or air resistance. Another air-driven apparatus is shown at http://canariosmazuelas.es/2009/09/limpiadora-de-semillas/ for cleaning bird seed. The bird seed mixture is feed into a ramp and a fan pushes the husks up the ramp into a husk container while the heavier seeds slide down to a seed container. The aforementioned devices separate husks but are not adjustable. For example, some bird seed is heavier or bigger than others. Some husks have more air resistance than others. Moisture content can also affect both weight and air resistance during separation. Patents such as U.S. Pat. Nos. 1,042,836; 1,420,593 and 4,979,622 attempt to compensate for this problem using mechanical structure adjustments. Such techniques can become unwieldy to operate—such as those observed in U.S. Pat. No. 3,441,134. While the bird feeding industry continues to develop measures to enhance bird seed feeding, none were found in the prior art that incorporated a simple and easy means to customize husk separation from seed.

### SUMMARY OF THE INVENTION

The present invention has distinct features not found in prior art. The present invention is a small, compact apparatus and uses air flows. A main object of the invention is to segregate husk from commercially-available, bulk seed. A user can pour copious amount of seed into one end of the apparatus and husk is separated while the mixture free falls through an air stream generated by an internal fan.

Another object is to minimize seed from contacting hard surfaces that could break up the seed further. Once inside the apparatus, the seed does not come in contact with any mechanical structure nor is any mechanical structure used during the separation of the husks from the seeds. A physical divider inside the present invention guides fugitive husk away from the seed but it is not used during the segregation process.

Another object is to allow users to adjust the level of seed segregation that takes place. Users can adjust the airflow rate to cause different sizes of husk and seed to be segregated. For example, setting the fan speed to a higher revolution per minute (RPM) causes lightweight husk and smaller seed to drop out of the airstream. Conversely, setting the fan speed to a lower RPM causes only the husk to drop out. The fan speed is adjustable and typically controlled by the use of an adjustable voltage power supply going into a direct current (D.C.) motor. Larger seeds will need higher air speed while smaller seeds will need lower air speed. Controlling of the fan speed also determines how well the apparatus cleans the seeds. Increasing the fan speed can result in more husks being removed at the risk of some seeds being blown into the husk container, but the advantage is more thoroughly cleaned seeds. Decreasing the fan can result in more husks collected in the seed container but the advantage is less seeds wasted. An optimal fan speed will result in cleaned seeds with little or no waste for a particular seed size.

Another object is to allow users to determine the size of seed material that exits the device. The case of the unit has vents that allow for fine screens to be placed inside and limit fine materials and husk particles from exiting the unit.

### BRIEF DESCRIPTION OF THE DRAWINGS

The foregoing summary, as well as the following detailed description of the preferred embodiments, will be better understood when read in conjunction with the appended drawings. For the purpose of illustrating the invention, there are shown in the drawings embodiments which are presently preferred. It should be understood, however, that the invention is not limited to the precise arrangements and instrumentalities shown.

FIG. 1 shows the outside of the apparatus.

FIG. 2 shows a second perspective views of the outside of the apparatus.

FIG. 3 shows the internal view of the apparatus with the front removed.

FIG. 4 illustrates the operation of the apparatus.

FIG. 5 shows an alternate embodiment of the apparatus.

Other aspects of the present invention shall be more readily understood when considered in conjunction with the accompanying drawings, and the following detailed description, neither of which should be considered limiting.

### DETAIL DESCRIPTION OF THE INVENTION

In this description, the directional prepositions of up, upwardly, down, downwardly, front, back, top, upper, bottom, lower, left, right and other such terms refer to the device as it is oriented and appears in the drawings and are used for convenience only; they are not intended to be limiting or to imply that the device has to be used or positioned in any particular orientation. All illustrations of the drawings are for the purpose of describing selected versions of the present invention and are not intended to limit the scope of the present invention. The present invention is directed to seed cleaning apparatus and a method thereof using the example of a bird seed cleaner which separates bird seed husks from bird seeds. Bird seed cleaners are only one type of seed cleaner. Other seed cleaners include, but are not limited to, those in this document. It is understood that their use in the description is intended to demonstrate the present subject matter, but not in a limited or exclusive or exhaustive sense.

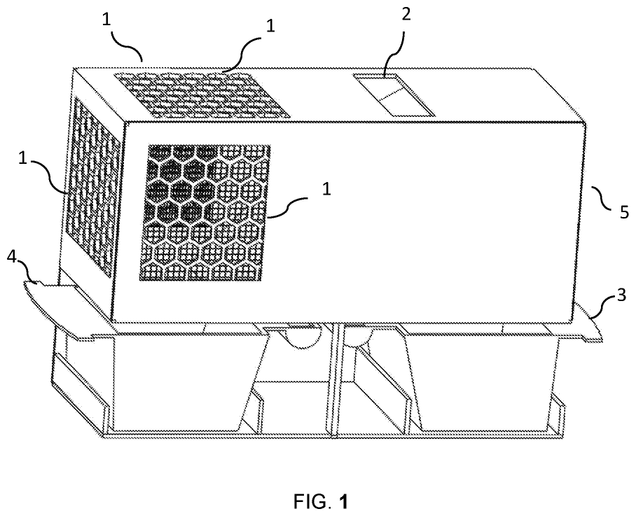

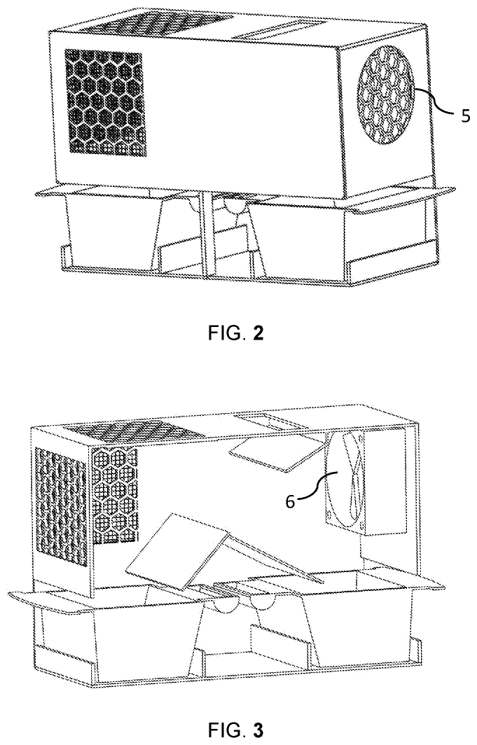

FIG. 1 showing the outside of an embodiment of the apparatus comprised of a rectangular-shaped, hollow case made of a rigid material such as, but not limited to plastic, metal and the like. An end of said case having exhaust vents 1, configured with apertures to allow for the outward exhaust air. Said exhaust vents 1 being located on one or more sides of the apparatus comprised of a plurality of apertures thereon. In another embodiment, the vents having internal slots allowing for a fine-mesh screen (made of but not limited to plastic and metal wire etc.) to be installed therein, thereby allowing seed fines to remain in the chamber when exhaust air is escaping. Said case also having a slot 2 located proximally on the apparatus comprised of a rectangular-shaped orifice configured perpendicular to the longitudinal axis of the device and allowing seed to be entered into the apparatus. FIG. 2 shows the inward air vent 5 on one end of the apparatus. Said inward air vent 5 also having a plurality of apertures thereon.

FIG. 3 showing fan 6 and the internal view of the apparatus. Said fan being comprised of a rotary-blade fan with a multitude of vanes and including, but not limited to battery generated D.C. power or A.C. household current power. A range of conventional controls also being connected to said fan 6 such as, but not limited to a speed selection knob and an on and off switch along with a power cable port.

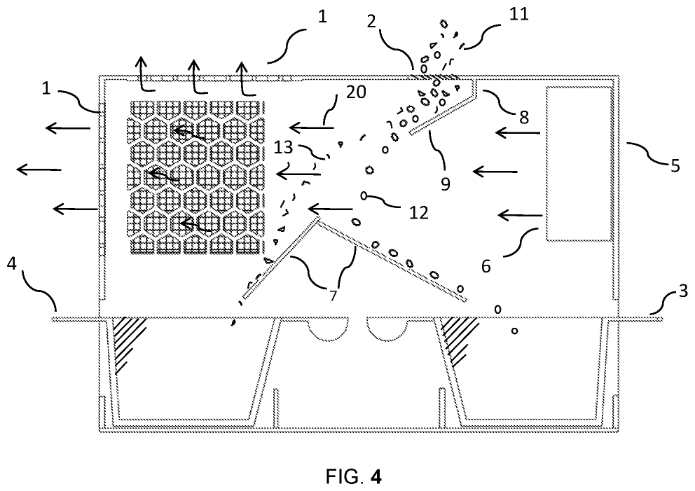

FIG. 4 showing a section view of the apparatus cleaning bird seed method. Said bird seed mixture 11 entering the device through feed slot 2 and directed into airstream by means of vertical air deflector 8 having an L-shape and deflector ramp 9 (both made of a rigid material such as but not limited to metal, plastic and the like). The seed mixture 11 being entrained in airstream 20 generated by the aforementioned fan 6 (flowing toward exhaust vents 1). Once seed being segregated, portions of the seed mixture 11 dropping from airstream and directed to seed container 3 and husk container 4 by means of Said containers 3 and 4 being comprised of square-shaped, hollow chambers and made of a rigid material such as, but not limited to plastic, metal and the like.

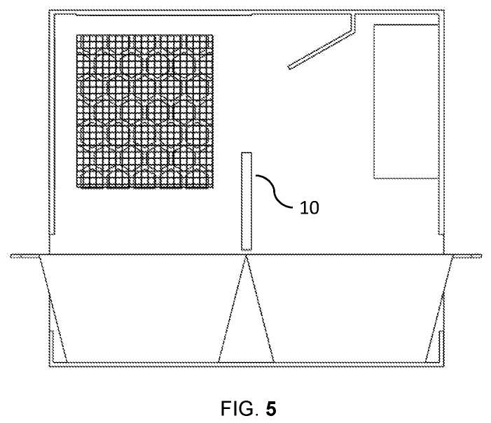

Seed container 3 and husk container 4 being configured to allow a user to selectively slide them out of the apparatus to be emptied. The aforementioned vertical air deflector 8 and air deflector ramp 9 being selectively removable according to user preferences. The deflectors, 8 and 9 reducing the likelihood that the seeds and husks are pushed back out the feeder slot 2, and air deflector ramp 9 controlling the rate at which the seeds fall through the apparatus. Air deflector 8 and air deflector ramp 9 creating a low pressure assisting in pulling seeds from said feed seed slot 2. Bird seed mixture 11 falling through the airstream 20 and said seeds 12 and husks 13 experiencing different amounts of force. The deflection of the husks 12 being significantly higher than the seeds 13 due to husk 12 being lighter, and their irregular shape. The speed of said fan 6 being adjusted allowing husks 12 to be blown into husk container 4 and seeds 13 falling into seed container 3. The divider 7 prevents seeds from entering the husk container 4 and prevents husks from entering the seed container 3 once the seeds and husks leave the air stream. One embodiment using divider 7 as shown in FIG. 4 being configured as ramps and made of a rigid material such as plastic, metal and the like. Yet another embodiment using a single vertical separator plate 10 as shown in FIG. 5. Other embodiments may utilize a single ramp or a combination of a ramp and vertical separator also made of a rigid material such as plastic, metal and the like.

It is additionally noted and anticipated that although the device is shown in its most simple form, various components and aspects of the device may be differently shaped or slightly modified when forming the invention herein. As such those skilled in the art will appreciate the descriptions and depictions set forth in this disclosure or merely meant to portray examples of preferred modes within the overall scope and intent of the invention, and are not to be considered limiting in any manner. While all of the fundamental characteristics and features of the invention have been shown and described herein, with reference to particular embodiments thereof, a latitude of modification, various changes and substitutions are intended in the foregoing disclosure and it will be apparent that in some instances, some features of the invention may be employed without a corresponding use of other features without departing from the scope of the invention as set forth. It should also be understood that various substitutions, modifications, and variations may be made by those skilled in the art without departing from the spirit or scope of the invention.

What is claimed is:

1. A bird seed cleaning apparatus comprised of the following parts:
a.) a hollow case;
b.) a fan; and
c.) collection chambers.

2. The hollow case of claim 1 having inflow and exhaust vents thereon.

3. The inflow and exhaust vents of claim 2 having selectively-installed screens.

4. The hollow case of claim 1 having deflectors therein.

5. The collection chambers of claim 1 being selectively removable from the apparatus.

6. The fan of claim 1 having selectively adjustable speeds.

7. A method comprising:
1.) segregating husk from bird seed;
2.) minimizing seed contact with hard surfaces;
3.) adjusting the level of seed segregation; and
4.) adjusting the level of seed that exhausts from the apparatus.
